(19) United States
(12) Patent Application Publication
(10) Pub. No.: US 2019/0078930 A1
(43) Pub. Date: Mar. 14, 2019

(54) INTEGRATED SYSTEM AND METHOD FOR AISLE INVENTORY MANAGEMENT

(71) Applicant: Kiran Ravulapati, Plano, TX (US)

(72) Inventor: Kiran Ravulapati, Plano, TX (US)

(21) Appl. No.: 15/700,145

(22) Filed: Sep. 10, 2017

(51) Int. Cl. G01G 19/414; G06Q 10/08; G01G 19/415; G01G 19/42; G06F 3/14

(52) U.S. Cl. CPC G01G 19/4144; G06Q 10/0875; G06F 3/1423; G01G 19/42; G01G 19/415

(57) ABSTRACT

An integrated system and method for aisle inventory management and for locating inventory item is disclosed. The system includes a mat with sensors, which is laid on the shelf before placing products. The sensor mat registers inventory data on the shelf which includes area covered by the products and their collective weight. A unique identifier of the sensor mat and inventory data from the sensor mat are sent to a connected wireless router, which in turn will relay the sensor data to a central computer. The central computer system triggers an alert at a user interface unit associated with the worker when inventory on the shelf requires re-stocking of products. Further, a built-in bluetooth beacon installed in the sensor mat aids to locate the position of a user and transmits navigation instruction from the central computer system to the user interface unit associated with the user through a wireless network.

### BACKGROUND OF THE INVENTION

### A. Technical field

The present invention generally relates to inventory management and shopping guidance system. More specifically, the present invention relates to a system and method that facilitates to monitor and replenish aisle inventory and assists a customer or workers to locate an inventory item in the shopping facility.

### B. Description of related art

In retail environment, products are displayed on the shelves for purchase by the customers. Such retail sale facilities operational goal is to maintain the availability of product on shelf. However, attaining the 100% product availability is often a challenge due to operational reasons such as delay in reporting the unavailability of stock by a worker. Further in the dynamic retail sale facility, rearranging product displayed on the shelves, frequent change in price of the product is common. This often requires additional task of manually printing and displaying price tags which is error-prone and labor intensive and also updating the tags on the shelves incurs significant cost.

Another difficulty in today's retail environment are locating a particular product among the thousands of items arranged in the store. Even though the products are organized into aisles with descriptive signboards, customers often have hard time locating the products as these signboards are broad categories rather than specific products that customer searches. This problem is mitigated by the presence of store associates who can guide customers. However, the problem persists as store associates are not always guaranteed to be around.

Therefore, there is a need for a system that continuously monitors the availability of the product on-shelf and alerts the store management for timely restocking of aisles before the exhaustion of the products. Further, there is a need for a system that assists a customer or workers to locate an inventory item in the shopping space. Further, there is a need for a system that facilitates an automated management of price of the product displayed at aisles.

### SUMMARY OF THE INVENTION

The present invention relates to a system and method that facilitates to monitor and replenish aisle inventory and assists a customer or workers to locate an inventory item in the shopping space.

The system comprises a plurality of sensing mat located on the shelf upon which products are displayed, a central computer system, a plurality of user interfaces unit, at least one network and at least database. In an embodiment, the database comprises a memory to store an inventory database comprising inventory data corresponding to the inventory items in the plurality of shelves and location of the inventory items in the plurality of shelves, a map database comprising a map of the shopping space, product pricing data and so on. The sensor mat area is divided into grid of smaller blocks with a sensor in each block. In an embodiment, the sensor mat includes a weight sensor. The sensor mat detects the inventory present based on area covered by the products and their collective weight. The sensor mat transmits the sensed inventory data to a wireless router connected via a wire link. Further, the wireless router periodically relays the shelf inventory data to the central computer via a wireless network inside the store. Then the central computer system coupled to the at least one database receives the shelf inventory data and determines the shelves that need to be restocked. In an embodiment, a display module connected to the front of the sensor mat which is configured to display the inventory related data such as price of the products. In an embodiment, the displayed data could be periodically updated by the central computer system through the wireless router. In an embodiment, the system further comprises a built-in bluetooth beacon in the sensor mat that aids to locate the position of the user and transmits navigation information from the central computer system to the user interface unit through the wireless network.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a system for providing shopping assistance and aisle inventory management in accordance with one embodiment of the invention.

FIG. 2 exemplarily illustrates the implementation of the system in the shopping space in accordance with one embodiment of the present invention.

FIG. 3 is a flowchart illustrating the shopping assistance and aisle inventory management provided by the system in accordance with one embodiment of the invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

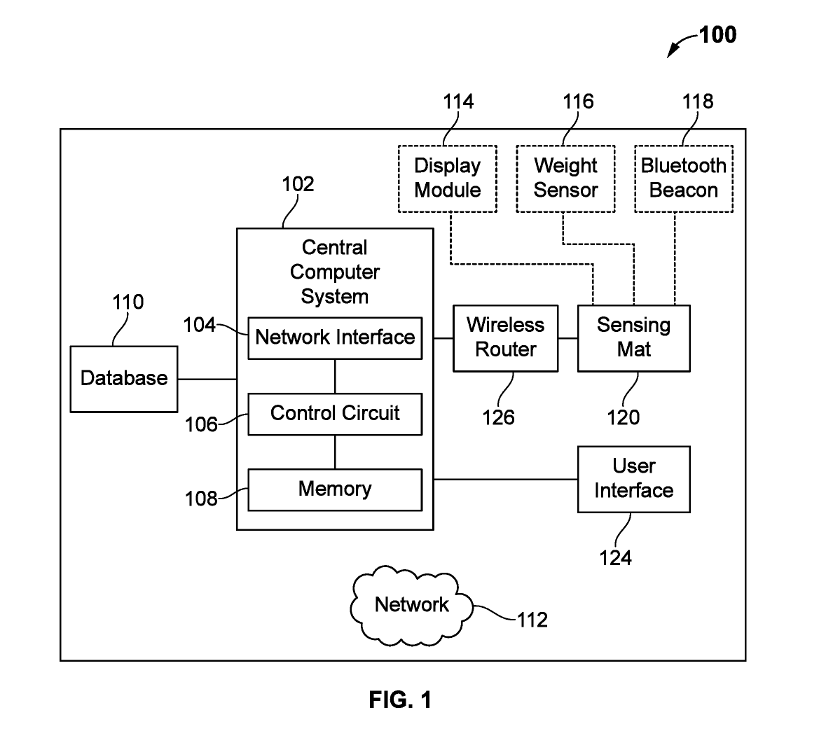

Referring to FIG. 1, a system 100 for providing assistance during shopping and management of aisle inventory is described. The system 100 comprises a plurality of sensing mat 120 located on the shelf upon which products are displayed, a central computer system 102, a plurality of user interfaces unit, at least one network 112 and at least one database 110. In an embodiment, the sensing mat 120 are rectangular in shape. In an embodiment, the sensing mat 120 could be of varied shapes. The rectangular sensing mat 120 are easily joined together to cover the entire shelf. The area of the sensing mat 120 surface is divided into grid of small rectangular blocks with a sensor located in each block. In an embodiment, the sensing mat 120 includes a weight sensor 116.

In an embodiment, the central computer system 102 is a computer based device and includes at least one control circuit 106, at least one memory 108 and at least one wired and/or wireless network interface 104. In an embodiment, the control circuit 106 may comprise a fixed-purpose hard-wired platform or can comprise a partially or wholly programmable platform, such as a microcontroller, an application specification integrated circuit, a field programmable gate array, and so on. This control circuit 106 is configured to carry out one or more of the steps, actions, and/or functions described herein, by using corresponding programming stored in the memory 108. In this illustrative example, the control circuit 106 operably couples to one or more memories 108. The memory 108 may be integral to the control circuit 106 or can be physically discrete (in whole or in part) from the control circuit 106 as desired. This memory 108 can serve, for example, to non-transitorily store the computer instructions that, when executed by the control circuit 106.

Additionally, at least one database 110 may be accessible by the central computer system 102. In an embodiment, the at least one database 110 may be integrated into the central computer system 102 or separate from it. In an embodiment, the at least one database 110 may be at the location of the shopping facility or remote from the shopping facility. In an embodiment, the database 110 residing in a connected server or in a cloud computing service. In an embodiment, regardless of location, the databases 110 comprise memory to store and organize certain data for use by the central computer system 102. In some embodiment, the at least one database 110 comprise a memory to store an inventory database comprising inventory data corresponding to the inventory items in the plurality of shelves and location of the inventory items in the plurality of shelves, a map database comprising a map of the shopping space, a product pricing data, offer data and discount data and so on.

In an embodiment, the central computer system 102 also wirelessly communicates with the plurality of user interface units 124. In an embodiment, the user interface units 124 include, but not limited to, mobile and/or handheld electronic devices, smart phones and portable computers such as tablet, pad-styled computers. In an embodiment, the user interface units 124 are configured to wirelessly communicate with the central computer system 102 via a wireless network, such as the wireless network 112 of the shopping facility. In an embodiment, the user interface units 124 configured to provide a user interface for interaction with the system 100. In an embodiment, these user interface unit 124 comprises a programming to allow it to interact with the central computer system 102. In an example, such programming may be in the form a computer application installed in the user interface unit 124. In an embodiment, the plurality of user interface units 124 comprises at least one user interface unit associated with a user and at least one user interface unit associated with a worker. In an embodiment, the wireless network communication 112 could be WiFi network, WiMax network, Wireless local area network.

In an embodiment, each sensor mat or sensing mat 120 also has a weight sensor 116 that detects the inventory data of products resting on the sensing mat 120. In an embodiment, inventory data from the sensing mat 120 constitutes the area covered by the products and their collective weight. In an embodiment, the backend of sensing mat 120 is linked with a wire to connect a wireless router 126 at the end of the aisle. In an embodiment, the wires carry both power to the sensing mat 120 and data to & from the sensor/sensing mat 120. In an embodiment, the wireless router 126 could receive as well as transmit data. In an embodiment, when a product is placed on the sensor mat, the product's presence is sensed and passed to the router 126, which in turn will relay the sensed inventory data to the central computer 102 located inside the store via the wireless network 112. The central computer 102 in turn would send the data to the database 110 to identify the shelf that requires re-stocking of products. In an embodiment, the central computer system 102 communicates with each of the sensing mat 120 through the wireless router 126.

In an embodiment, the availability of the product is continuously monitored by the sensor and transmitted to the router 126, which in turn relay the message to the central computer system 102. The central computer 102 in turn will send the data to the database 110. Further, the central computer 102 monitors continuously to determine the shelf requiring restock. In an embodiment, the central computer 102 triggers an alert to the user interface device associated with the worker as a remainder or notification to restock the shelf. In response to the alert, the store management would take necessary corrective actions, in real time, to remedy the problem of low inventory on the shelf. Thus, the proposed inventory monitoring system 100 ensures that shelves are restocked periodically before an out of stock event occurs. In an embodiment, the system 100 is updated the system to indicate that the shelf is replenished by scanning the sensor mat's unique identifier via the user interface associated with the worker. In an embodiment, the system is updated via the sensors. In an embodiment, each of the plurality of sensing mat includes a display module 114. In an embodiment, the display module 114 is attached at the front end of the sensing mat 120. In an embodiment, the display module 114 is configured to display product data of the inventory item which is automatically updated by the central computer system 102. In an embodiment, the product data includes a product price, product offers or product discount.

In an embodiment, each of the plurality sensing mat 120 has a built-in beacon that sends out the sensor mat's 120 unique id via a wireless signal at specified time intervals. In an embodiment, each of the plurality sensing mat 120 has a built-in bluetooth beacon 118 that sends out the sensor mat's 120 unique id via a bluetooth signal at specified time intervals. In an embodiment, the user interface unit associated with the user responds to the signal, which is sent back to the central computer system 102, where the customer's location inside the store is estimated by triangulating bluetooth signals emanating from the nearby sensor mat 120. The system 100 is configured to transmit location/navigation information to the user interface unit associated with the user to guide the user towards the shelf location of the product. In another embodiment, the system 100 is configured to determine the user location information via a software application associated with the user interface unit that receives said signals. In another embodiment, the system 100 is configured to determine the user location information via a wireless network.

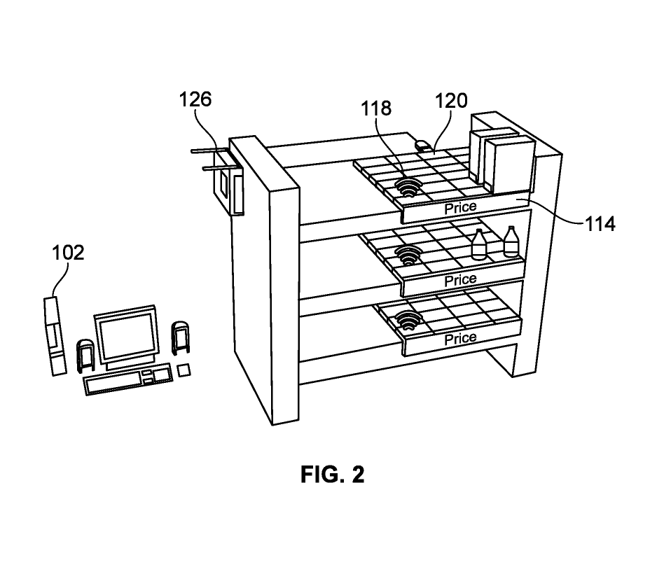

FIG. 2 illustrates the implementation of the system 100 in the shopping environment, where the sensing mat 120 is spread below the products of the shopping environment. The sensing mat 120 area are divided into grid of smaller blocks with a sensor in each block. In an embodiment, the sensor mat includes a weight sensor 116. The sensing mat 120 detects the inventory present based on area covered by the products and their collective weight. The sensing mat 120 transmits the sensed inventory data to the router 126 which is connected by a wired link. Further, the wireless router 126 periodically relays the shelf inventory data to the central computer 102 via the wireless network 112 inside the store. Then the central computer system 102 receives the shelf inventory data and determines the shelves that need to be restocked. In an embodiment, the display module 114 connected to the front of the sensor mat 120 displays the product data relevant to the inventory item. In an embodiment, the displayed data could be periodically updated by the central computer system 102 through the wireless router 126. The built-in bluetooth beacon 118 in the sensor mat 120 aids to locate the position of the user and transmits navigation information from the central computer system 102 to the user interface unit through the wireless network 112.

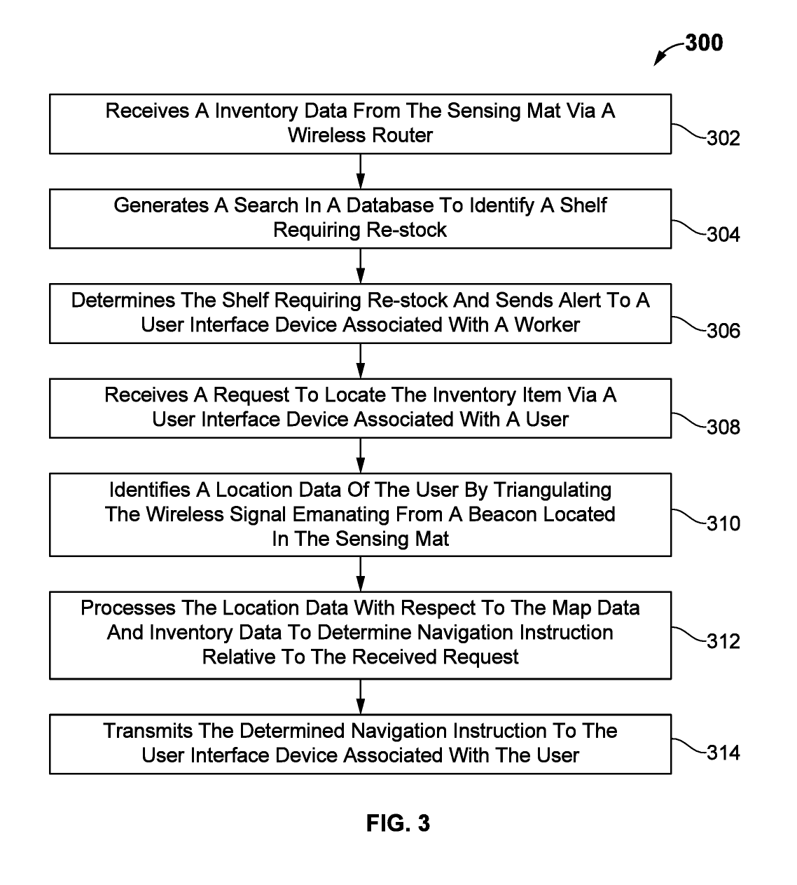

FIG. 3 is a flowchart 300 illustrating the shopping assistance and aisle inventory management provided by the system 100 in accordance with one embodiment of the invention. At step 302, the central computing system 102 receives the inventory data of the sensing mat from the wireless router 126 via a wireless network 112. At step 304, the central computing system 102 generates a search in the database 110 to identify a shelf requiring re-stock. At step 306, the central computer system 102 determines the shelf requiring re-stock and sends alert to a user interface device associated with a worker. At step 308, the central computer system 102 receives a request to locate the inventory item via a user interface device associated with a user. At step 310, the central computer system 102 identifies a location data of the user by triangulating the wireless signals emanating from the beacon installed in the sensing mat 120. At step 312, the central computer system 102 processes the location data with respect to the map stored in the database 110 and inventory data to determine navigation instruction relative to the received request. At step 314, the central computer system 102 transmits the determined navigation instruction to the user interface device associated with the user.

Preferred embodiments of this invention are described herein, including the best mode known to the inventors for carrying out the invention. It should be understood that the illustrated embodiments are exemplary only, and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. An integrated system for aisle inventory management, comprising:
a sensing mat with a unique identifier installed above a plurality of shelves receiving one or more inventory items, wherein the sensing mat is sectioned into a grid of blocks, said sensing mat includes a sensor on each of said blocks and configured to sense inventory data including area occupied by the inventory item and weight of the inventory item;
a display module communicatively coupled with the sensing mat configured to display a product data relating to the inventory item;
a beacon installed in the sensing mat configured to broadcast a wireless signal associated with the unique identifier of the sensing mat at specified time intervals;
a wireless router communicatively coupled with the sensing mat, configured to receive and transfer data from the display unit and sensing mat;
a memory unit to store:
an inventory database comprising one or more inventory data corresponding to the inventory items in the plurality of shelves and location of the inventory items in the plurality of shelves, a map database comprising a map data of the shopping space;
a central computer system communicatively connected to the sensing mat, the display module, the memory unit, and one or more user interface unit via a wireless network, the central computer system is configured to:
receive inventory data periodically from the sensing mat;
generate a search in the database to identify a shelf requiring re-stock;
determines the shelf requiring re-stock and sends alert to a user interface device associated with a worker;
receives a request to locate the inventory item from a user interface device associated with a user;
identifies a location data of the user by triangulating wireless signals associated with unique identifier emanating from the beacon;
processes the location data with respect to the map data and inventory data to determine navigation instruction relative to the received request; and
transmits the determined navigation instruction to the user interface device associated with the user.

2. The system according to claim 1, wherein the central computer is further configured to periodically update the data to be displayed by the display unit.

3. The system according to claim 1, wherein the sensor is a weight sensor.

4. The system according to claim 1, wherein the user interface unit is at least one of tablet computers, personnel computers, personnel digital assistants, smart phones, smart televisions, palm tops, phablets and laptops.

5. The system according to claim 1, wherein the memory unit is at least one of a volatile memory, non-volatile memory, Read Only memory (ROM), Random Access Memory (RAM), and a flash memory.

6. The system according to claim 1, wherein the user is at least one of a customer or a worker.

7. The system according to claim 1, wherein the wireless network is at least one of a Local Area Network, a Wide Area Network, a Wireless Network, a telecommunication network, a mobile network, and an Internet.

8. The system according to claim 1, wherein the beacon is a bluetooth beacon.

9. The system according to claim 1, wherein the wireless signal is a bluetooth signal.

10. The system according to claim 1, wherein the product data is at least one a product price, product offers or product discount.

11. A method for aisle inventory management, comprising the steps of:
receiving at a central computer system, via a wireless router, inventory data from one or more sensing mat;
generating at the central computer system, a search in the database to identify a shelf requiring re-stock;
determining at the central computer system, the shelf requiring re-stock and sends alert to a user interface device associated with a worker;
receiving at the central computer system, via a wireless network, a request to locate an inventory item from a user interface device associated with a user;
identifying at the central computer system, a location data of the user by triangulating wireless signals associated with unique identifier emanating from one or more beacon;
processing at the central computer system, the location data with respect to a map data and inventory data stored in a memory unit to determine navigation instruction relative to the received request; and
transmitting at the central computer system, the determined navigation instruction to the user interface device associated with the user, via the wireless network.

12. The method according to claim 11, further comprising a step of updating at the central computer system, the product data to be displayed by a display module coupled to the sensor mat via the wireless router.

13. The method according to claim 11, wherein the user interface unit is at least one of tablet computers, personnel computers, personnel digital assistants, smart phones, smart televisions, palm tops, phablets and laptops.

14. The method according to claim 11, wherein the memory unit is at least one of a volatile memory, non-volatile memory, Read Only memory (ROM), Random Access Memory (RAM), and a flash memory.

15. The method according to claim 11, wherein the user is at least one of a customer or a worker.

16. The method according to claim 11, wherein the wireless network is at least one of a Local Area Network, a Wide Area Network, a Wireless Network, a telecommunication network, a mobile network, and an Internet.

17. The method according to claim 11, wherein the beacon is a bluetooth beacon.

18. The method according to claim 11, wherein the wireless signal is a bluetooth signal.

19. The method according to claim 11, wherein the product data is at least one a product price, product offers or product discount.

20. A sensing mat to determine availability of an inventory item displayed in an aisle inventory, comprising:
a sensing mat with a unique identifier installed above a plurality of shelves receiving one or more inventory items, wherein the sensing mat is sectioned into a grid of blocks, said sensing mat includes a sensor on each of said blocks and configured to sense inventory data including area occupied by the inventory item and weight of the inventory item.
